(19) United States
(12) Patent Application Publication
(10) Pub. No.: US 2022/0279698 A1
(43) Pub. Date: Sep. 8, 2022

(54) WORKING MACHINE

(71) Applicant: KUBOTA CORPORATION, Osaka (JP)

(72) Inventors: Fumiya YOSHIMURA, Sakai-shi (JP); Kotaro YAMAGUCHI, Sakai-shi (JP); Kenji TAMATANI, Sakai-shi (JP); Takanori MORIMOTO, Sakai-shi (JP); Ken SAKUTA, Sakai-shi (JP)

(21) Appl. No.: 17/751,804

(22) Filed: May 24, 2022

Related U.S. Application Data
(63) Continuation of application No. PCT/JP2020/046481, filed on Dec. 14, 2020.

(30) Foreign Application Priority Data
Dec. 18, 2019 (JP) 2019-228666

(51) Int. Cl. A01B 69/00; A01C 23/00; G05D 1/02

(52) U.S. Cl. CPC A01B 69/004; A01C 23/007; G05D 1/0219; B62D 49/06

(57) ABSTRACT

A working machine includes a machine body, a linkage capable of linking a working device including a spreader to the machine body, an automatic travel controller to cause the machine body to perform automatic travel according to a planned travel route, a range acquirer to acquire a spreading work range that is a range where spreading work is done by the spreader in a front-rear direction thereof, and a work setter to set a work start position and a work end position for the spreader so that the work start position and the work end position are at different positions according to the spreading work range acquired by the range acquirer.

### CROSS REFERENCE TO RELATED APPLICATIONS

This application is a continuation application of International Application No. PCT/JP2020/046481, filed on Dec. 14, 2020, which claims the benefit of priority to Japanese Patent Application No. 2019-228666, filed on Dec. 18, 2019. The entire contents of each of these applications are hereby incorporated herein by reference.

### BACKGROUND OF THE INVENTION

### 1. Field of the Invention

The present invention relates to a working machine with a working device linkable thereto.

### 2. Description of the Related Art

The technique disclosed in Japanese Unexamined Patent Application Publication No. 2018-39 is known as a technique to prepare a travel route (work/travel line) for automatic travel of a working machine such as tractor. A working vehicle (working machine) of Japanese Unexamined Patent Application Publication No. 2018-39 includes an acquiring unit to acquire position data of an outer periphery of an agricultural field, and a work setting unit to set, on the basis of the position data, a work/travel line for travel of a travel machine body (machine body) in the agricultural field.

### SUMMARY OF THE INVENTION

In Japanese Unexamined Patent Application Publication No. 2018-39, a work/travel line (planned travel route) can be prepared and work can be done while automatic travel is performed along the work/travel line. However, when the working device is a spreader such as a fertilizer spreader or an agricultural chemical spreader, since a work range in a front-rear direction differs depending on the category of work done by the working device, some areas may be left with no work done and work efficiency may decrease.

Preferred embodiments of the present invention provide working machines, each being capable of accurately and efficiently doing work at intended positions.

A working machine according to an aspect of a preferred embodiment of the present invention includes a machine body, a linkage capable of linking a working device including a spreader to the machine body, an automatic travel controller to cause the machine body to perform automatic travel according to a planned travel route, a range acquirer to acquire a spreading work range that is a range where spreading work is done by the spreader in a front-rear direction thereof, and a work setter to set a work start position and a work end position for the spreader so that the work start position and the work end position are at different positions according to the spreading work range acquired by the range acquirer.

The working machine further includes an input to receive input of the spreading work range such that the spreading work range is associated with the spreader, wherein the range acquirer is configured or programmed to acquire the spreading work range received by the input.

The working machine further includes a storage to store the spreading work range received by the input, wherein the input includes a display device to display an input screen to receive input of the spreading work range, and the storage is configured or programmed to store the spreading work range inputted into and received by the input screen and the spreader corresponding to the spreading work range such that the spreading work range and the spreader are associated with each other.

The working machine further includes a storage to store the spreading work range received by the input, wherein the storage stores another type of the working device other than the spreader and a pre-set work range such that the other type of the working device and the pre-set work range are associated with each other, the range acquirer is configured or programmed to acquire, if the working device linked to the linkage is the spreader, the spreading work range inputted into and received by the input and associated with the spreader from the storage, and acquires, if the working device linked to the linkage is the other type of the working device other than the spreader, the work range from the storage, and the work setter is configured or programmed to set the work start position and the work end position for the working device linked to the linkage so that the work start position and the work end position are at different positions according to the spreading work range or the work range acquired by the range acquirer.

The working machine further includes a controller to control the working device linked to the linkage according to the work start position and the work end position set by the work setter, wherein the controller is configured or programmed to cause the working device linked to the linkage to start doing work when the working device has passed through the work start position and causes the working device to stop doing the work when the working device has passed through the work end position.

The working machine further includes a route generator to prepare the planned travel route, wherein the work setter is configured or programmed to set, according to the working device linked to the linkage, the work start position and the work end position for the working device on the planned travel route.

The above and other elements, features, steps, characteristics and advantages of the present invention will become more apparent from the following detailed description of the preferred embodiments with reference to the attached drawings.

### BRIEF DESCRIPTION OF THE DRAWINGS

A more complete appreciation of preferred embodiments of the present invention and many of the attendant advantages thereof will be readily obtained as the same becomes better understood by reference to the following detailed description when considered in connection with the accompanying drawings described below.

FIG. 1 shows a block diagram of a working machine.

FIG. 2 illustrates a raising/lowering device.

FIG. 3A illustrates an agricultural field map and a planned travel route.

FIG. 3B illustrates a work range.

FIG. 3C illustrates a spreading work range.

FIG. 4 illustrates an example of a reference setting screen.

FIG. 5 illustrates an example of a map registration screen.

FIG. 6A illustrates how an outline of an agricultural field (agricultural field map) is determined from a traveled path.

FIG. 6B illustrates how an outline of an agricultural field (agricultural field map) is determined from points of turn on a traveled path.

FIG. 6C illustrates how an outline (agricultural field map) is determined from switch operations during travel.

FIG. 7 illustrates an example of an area setting screen.

FIG. 8 illustrates an example of a work selection screen.

FIG. 9A illustrates an example of a first settings screen.

FIG. 9B illustrates an example of a second settings screen.

FIG. 10A is a diagram in which unit work segments are prepared in a work area.

FIG. 10B illustrates a unit work segment differing from those of FIG. 10A.

FIG. 10C illustrates a unit work segment differing from those of FIGS. 10A and 10B.

FIG. 11 illustrates how a planned travel route is prepared.

FIG. 12A is a first diagram illustrating setting of work start positions and work end positions by a work setting unit.

FIG. 12B is a second diagram illustrating setting of work start positions and work end positions by the work setting unit.

FIG. 12C is a third diagram illustrating setting of work start positions and work end positions by the work setting unit.

FIG. 13 illustrates an example of automatic travel.

FIG. 14 is a general side view of the working machine.

### DETAILED DESCRIPTION OF THE PREFERRED EMBODIMENTS

The preferred embodiments will now be described with reference to the accompanying drawings, wherein like reference numerals designate corresponding or identical elements throughout the various drawings. The drawings are to be viewed in an orientation in which the reference numerals are viewed correctly.

The following description discusses preferred embodiments of the present invention with reference to drawings.

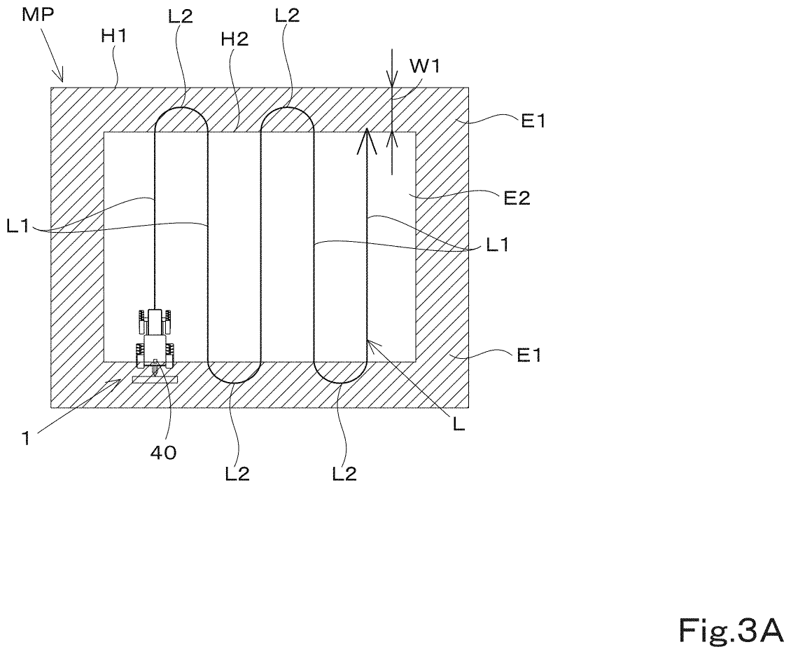

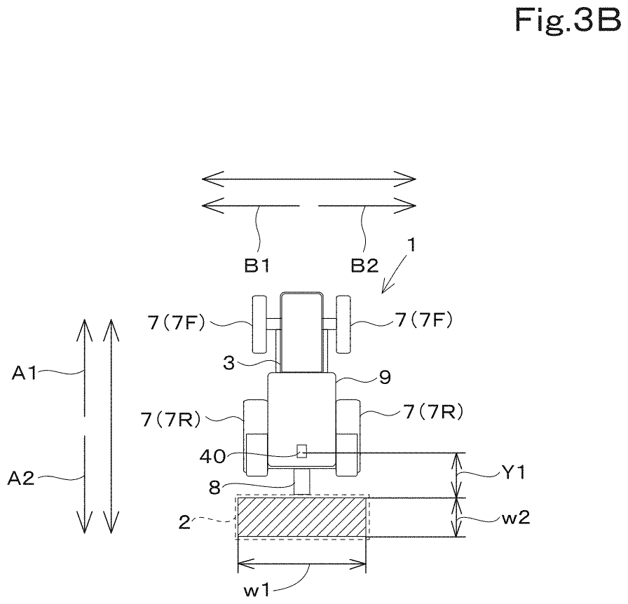

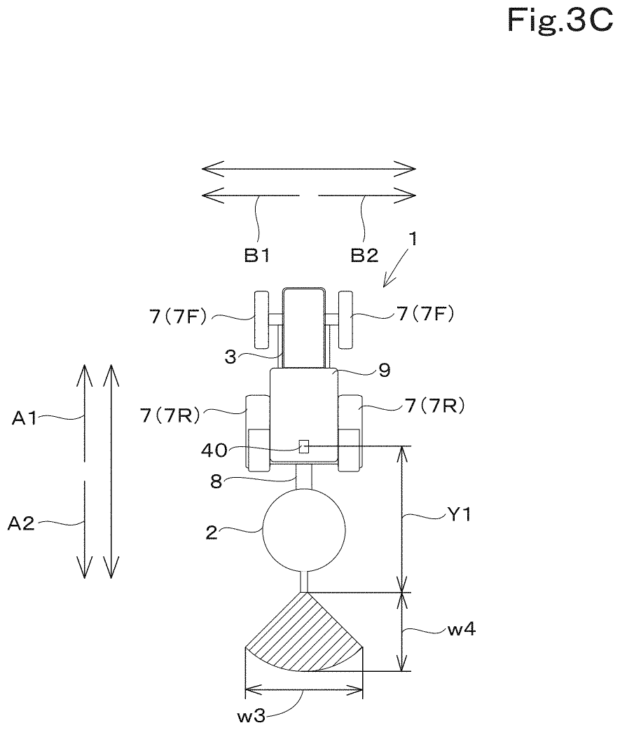

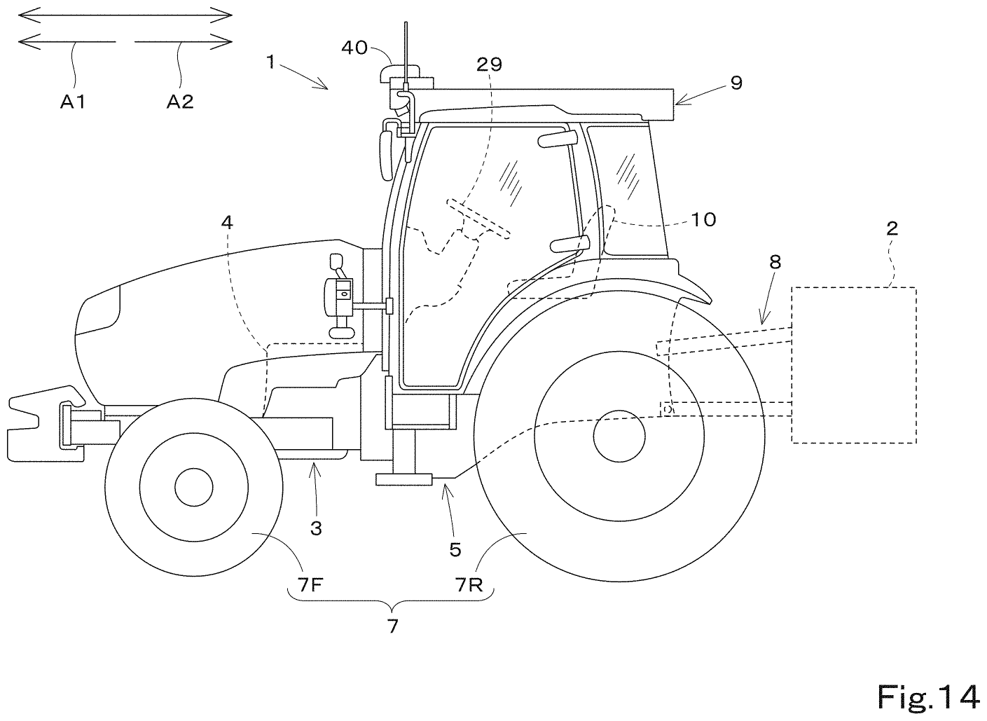

FIG. 14 illustrates a tractor, which is an example of a working machine 1. The working machine 1 is discussed using a tractor as an example, but the working machine 1 is not limited to a tractor and may be a rice transplanter or a combine. In preferred embodiments of the present invention, descriptions are based on the assumption that the front of the working machine 1 as seen from an operator (driver) seated on an operator's seat 10 (indicated by arrow A1 in FIGS. 3B, 3C, and 14) is “front”, the rear of the working machine 1 as seen from the operator is “rear” (indicated by arrow A2 in FIGS. 3B, 3C, and 14), the left side of the working machine 1 as seen from the operator is “left” (near side in FIG. 14, indicated by arrow B1 in FIGS. 3B and 3C), and the right side of the working machine 1 as seen from the operator is “right” (far side in FIG. 14, indicated by arrow B2 in FIGS. 3B and 3C). The descriptions are also based on the assumption that a horizontal direction orthogonal to a front-rear direction of the working machine 1 is a width direction.

As illustrated in FIG. 14, the working machine 1 includes: a machine body (travel vehicle body) 3 with a traveling device 7; a prime mover 4; and a transmission 5. The traveling device 7 includes front wheel(s) 7F and rear wheel(s) 7R. The front wheels 7F may be tire-shaped wheels and may be crawler-shaped wheels. The rear wheels 7R also may be tire-shaped wheels and may be crawler-shaped wheels. The prime mover 4 is a diesel engine, an electric motor, and/or the like. The transmission 5 is capable of changing driving forces for the traveling device 7 by changing speed stages and switching the traveling state of the traveling device 7 between forward and rearward traveling states. The machine body 3 is provided with a cabin 9, and the cabin 9 is provided with the operator's seat 10 therein.

The machine body 3 is provided with a linkage at the rear thereof. The linkage includes a swinging drawbar which connects a working device 2 and the machine body 3 but does not raise or lower the working device 2, a raising/lowering device 8 which includes a three-point linkage or the like and which raises and lowers the working device 2, or the like. The working device 2 can be attached to and detached from the linkage. By linking the working device 2 to the linkage, it is possible for the machine body 3 to tow the working device 2. Examples of the working device 2 at least include spreaders. Examples of the spreaders include a fertilizer spreader (broadcaster), an agricultural chemical spreader for spreading agricultural chemicals, a water spreader for spreading water, and the like. Examples of the working device further include a cultivator for cultivation, a transplanter for planting, a mower for mowing grass or the like, a tedder for tedding grass or the like, a rake for raking grass or the like, a baler for baling grass or the like, and the like, in addition to the above-described spreaders. Note that the following description discusses an example case in which a fertilizer spreader as a spreader is linked to the linkage.

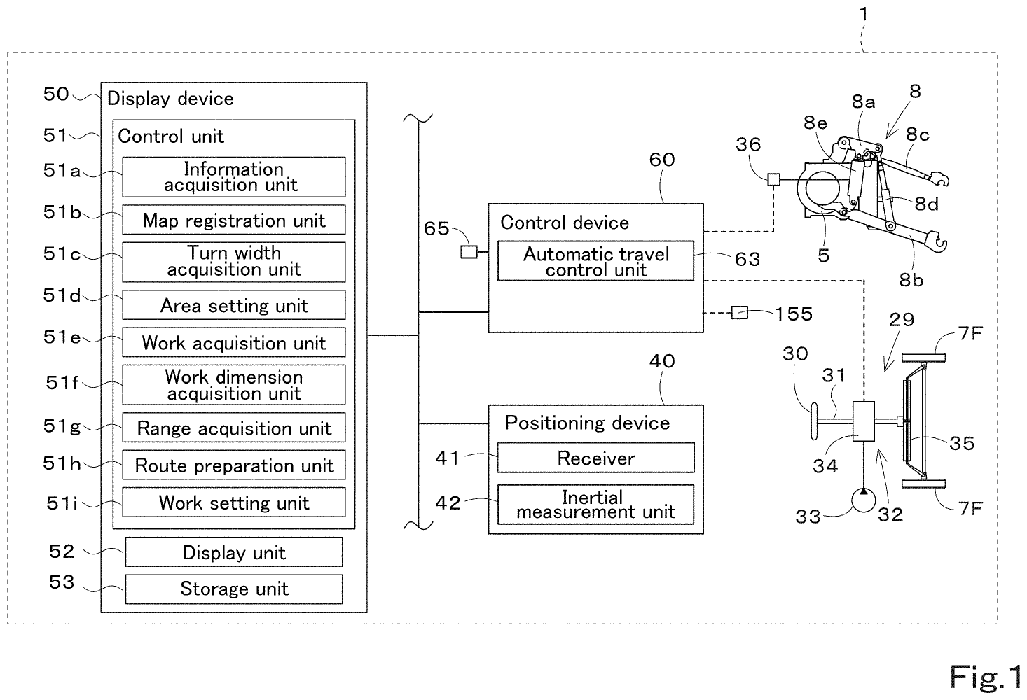

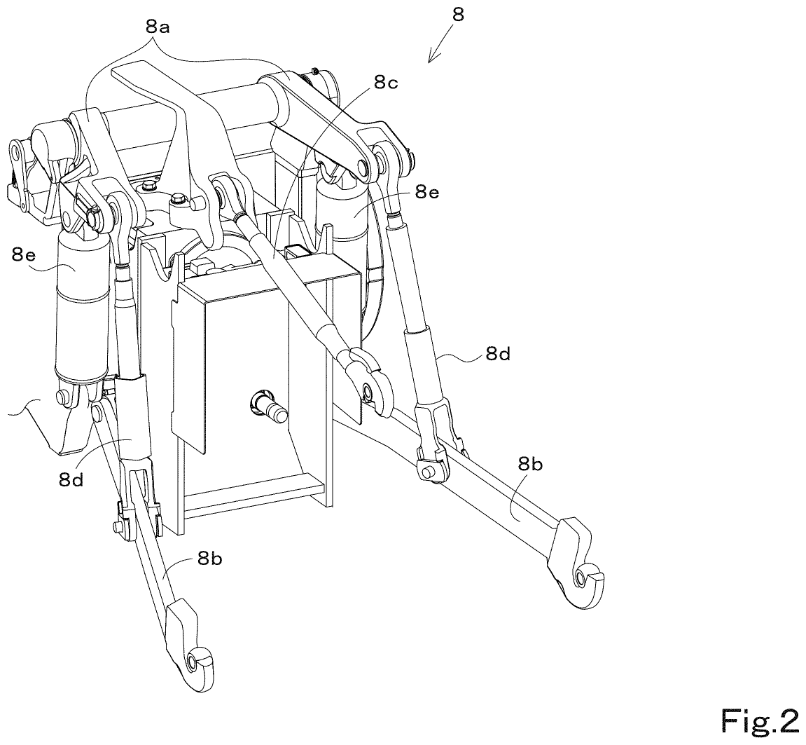

As illustrated in FIGS. 1 and 2, the raising/lowering device 8 includes lift arms 8a, lower links 8b, a top link 8c, lift rods 8d, and lift cylinders 8e. A front end of each lift arm 8a is supported on an upper rear portion of a case (transmission case) housing the transmission 5 such that the lift arm 8a is swingable up and down. The lift arm 8a is driven by a corresponding lift cylinder 8e to swing (raised or lowered). The lift cylinder 8e includes a hydraulic cylinder. The lift cylinder 8e is connected to a hydraulic pump via a control valve 36. The control valve 36 is a solenoid valve or the like to cause the lift cylinder 8e to extend and retract.

As illustrated in FIG. 1, a front end of each lower link 8b is supported on a lower rear portion of the transmission 5 such that the lower link 8b is swingable up and down. A front end of the top link 8c is supported, at a position higher than the lower link 8b, on a rear portion of the transmission 5 such that the top link 8c is swingable up and down. Each lift rod 8d connects a corresponding lift arm 8a and a corresponding lower link 8b. The working device 2 is linked to rear portions of the lower links 8b and the top link 8c. When the lift cylinders 8e are driven (extend or retract), the lift arms 8a ascend or descend, and the lower links 8b connected to the lift arms 8a via the lift rods 8d also ascend or descend. With this, the working device 2 swings up or down (raised or lowered) about front portions of the lower links 8b.

As illustrated in FIG. 1, the working machine 1 includes a steering unit 29. The steering unit 29 includes a steering wheel 30, a rotation shaft (steering shaft) 31 which rotates as the steering wheel 30 rotates, and an assist mechanism (power steering mechanism) 32 to assist steering performed using the steering wheel 30. The assist mechanism 32 includes a hydraulic pump 33, a control valve 34 supplied with hydraulic fluid discharged from the hydraulic pump 33, and a steering cylinder 35 which is actuated by the control valve 34. The control valve 34 is a solenoid valve which is actuated according to a control signal. The control valve 34 is, for example, a three-way switching valve which achieves multi-position switching by movement of a spool or the like. The positions of the control valve 34 can also be switched by steering by the steering shaft 31. The steering cylinder 35 is connected to arms (knuckle arms) which change the orientation of the front wheels 7F.

Therefore, upon operation of the steering wheel 30, the position and the degree of opening of the control valve 34 change according to the steering wheel 30, and the steering cylinder 35 extends or retracts leftward or rightward according to the position and the degree of opening of the control valve 34, making it possible to change the steering direction of the front wheels 7F. Note that the foregoing steering unit 29 is an example, and the foregoing configuration does not imply limitation.

As illustrated in FIG. 1, the working machine 1 includes a positioning device 40. The positioning device 40 is capable of detecting the position thereof (measured position information including latitude and longitude) by a satellite positioning system (positioning satellites) such as D-GPS, GPS, GLONASS, BeiDou, Galileo, and/or Michibiki. Specifically, the positioning device 40 receives satellite signals (positions of positioning satellites, time of transmission, correction information, and/or the like) from the positioning satellites, and detects the position (e.g., latitude and longitude) of the working machine 1, i.e., a machine body position VP1, on the basis of the satellite signals. The positioning device 40 includes a receiver 41 and an inertial measurement unit (IMU) 42. The receiver 41 is a device which includes an antenna and/or the like and which receives satellite signals from the positioning satellites, and is attached to the machine body 3 separately from the inertial measurement unit 42. In the present preferred embodiment, the receiver 41 is attached to the machine body 3, e.g., the cabin 9. Note that the location at which the receiver 41 is attached is not limited to those described in preferred embodiments.

The inertial measurement unit 42 includes an acceleration sensor to detect acceleration, a gyroscope sensor to detect angular velocity, and/or the like. The inertial measurement unit 42 is provided on the machine body 3, for example, below the operator's seat 10, and is capable of detecting the roll angle, pitch angle, yaw angle, and/or the like of the machine body 3.

As illustrated in FIG. 1, the working machine 1 includes an input device. The input device is a device to receive various settings regarding the working machine 1. The input device is, for example, a display device 50 which is operable and which displays predetermined input screens M5 and M6 to receive input of settings, a switch via which the operation of inputting settings can be performed, and/or the like. In the present preferred embodiment, the input device is, for example, the display device 50 of the working machine 1. The display device 50 includes a control unit 51, a display unit 52, and a storage unit 53. The control unit 51 includes a CPU, electric/electronic circuit(s), and/or the like, and performs various control regarding the display device 50. The display unit 52 is operable, includes a panel or the like such as a liquid crystal panel, a touchscreen, and/or the like, and displays various information regarding the working machine 1.

The storage unit 53 includes nonvolatile memory(memories) and/or the like. The storage unit 53 stores, for example, application program(s) for assisting work and/or the like done by the working machine 1, and, upon startup of the application program(s), the display device 50 functions as a work assistance device to assist work. Note that, also when the display device 50 functions as a work assistance device, processing that the display device 50 as the work assistance device performs is performed by the control unit 51 which is hardware.

As illustrated in FIG. 1, the working machine 1 includes an information acquisition unit 51a, a map registration unit 51b, a turn width acquisition unit 51c, an area setting unit 51d, a work acquisition unit 51e, a work dimension acquisition unit 51f, a range acquisition unit 51g, a route preparation unit 51h, and a work setting unit 51i. In the present preferred embodiment, the display device 50 includes the information acquisition unit 51a, the map registration unit 51b, the turn width acquisition unit 51c, the area setting unit 51d, the work acquisition unit 51e, the work dimension acquisition unit 51f, the range acquisition unit 51g, the route preparation unit 51h, and the work setting unit 51i. The information acquisition unit 51a, the map registration unit 51b, the turn width acquisition unit 51c, the area setting unit 51d, the work acquisition unit 51e, the work dimension acquisition unit 51f, the range acquisition unit 51g, the route preparation unit 51h, and the work setting unit 51i are each composed of electric/electronic circuit(s) of the control unit 51 of the display device 50, program(s) stored in a CPU and/or the like of the control unit 51, and/or the like. Note that, in the present preferred embodiment, the information acquisition unit 51a, the map registration unit 51b, the turn width acquisition unit 51c, the area setting unit 51d, the work acquisition unit 51e, the work dimension acquisition unit 51f, the range acquisition unit 51g, the route preparation unit 51h, and the work setting unit 51i are composed of the control unit 51, but may include electric/electronic circuit(s) and/or the like other than the control unit 51, and may include, for example, a control device 60 of the working machine 1.

The information acquisition unit 51a acquires information regarding relative positions of the machine body 3 and the working device 2. The information acquisition unit 51a acquires information inputted into the display device 50. Specifically, the information acquisition unit 51a acquires a reference distance Y1 which is the distance from a predetermined position on the machine body 3 to a predetermined position on the working device 2. For example, as illustrated in FIG. 3B and 3C, the reference distance Y1 is the distance between the positioning device 40 and a front edge of a work range of the working device 2 in the front-rear direction (direction of travel).

Note that the reference distance need only be a reference for calculation of the relative positions of the machine body 3 and the working device 2. The reference distance may be the distance between the positioning device 40 and a rear edge of the linkage (raising/lowering device 8) (i.e., front portion of the working device 2) in the front-rear direction (direction of travel), and may be the distance from a rear edge of the machine body 3 to a front edge of a work range w2 of the working device 2.

Furthermore, the information acquisition unit 51a need only acquire information regarding the relative positions of the machine body 3 and the working device 2, and the information is not limited to information inputted into the input device (display device 50). Information regarding the relative positions of the machine body 3 and the working device 2 may be pre-stored in the storage unit 53 and the information acquisition unit 51a may acquire the information regarding the relative positions of the machine body 3 and the working device 2 from the storage unit 53.

The map registration unit 51b registers an agricultural field map MP of a certain agricultural field, for example, registers positions corresponding to the outline of a certain agricultural field. The map registration unit 51b acquires position information of the outline of the agricultural field on the basis of, for example, machine body position(s) VP1 detected by the positioning device 40 of the working machine 1, and stores the position information and the agricultural field in the storage unit 53 such that the position information and the agricultural field are associated with each other. Note that the map registration unit 51b need only be capable of registering agricultural field map(s) MP of certain agricultural field(s), and, for example, may externally acquire agricultural field map(s) MP via wireless or wired communication or a storage medium and register the agricultural field map(s) MP. A method of registering agricultural field map(s) MP is not limited to the above-described method.

The turn width acquisition unit 51c acquires a width (turn width) W1 of a turn area E1 which is an area where the machine body 3 makes a turn. The turn area E1 is, for example, an area including a footpath and its surrounding area. The turn width acquisition unit 51c acquires the turn width W1 by acquiring information inputted into the input device (display device 50) via the storage unit 53.

The area setting unit 51d sets an area in which the working device 2 does work as illustrated in FIG. 3A, that is, a work area E2 which is the agricultural field map MP excluding the turn area E1, on the agricultural field map MP. The area setting unit 51d sets the work area E2 on the basis of the turn width W1 acquired by the turn width acquisition unit 51c. The area setting unit 51d registers the work area E2 on the agricultural field map MP stored in the storage unit 53. The area setting unit 51d sets, as the work area E2, an area defined by an outline H2 that is offset inward from the outline H1 of the agricultural field map MP by the turn width W1.

Note that the area setting unit 51d need only be capable of setting the work area E2. For example, the area setting unit 51d may set the work area E2 on the agricultural field map MP upon designation of the position of the outline of the work area E2 by a pointer or the like on the agricultural field map MP displayed on the display unit 52 of the display device 50. A method thereof is not limited to the method as described above.

The work acquisition unit 51e acquires information regarding the working device 2 attached to the linkage (raising/lowering device 8), work content (work category) of the working device 2, and/or the like. The work acquisition unit 51e acquires information regarding the working device 2, the work content, and/or the like by acquiring information inputted into the input device (display device 50) via the storage unit 53. For example, the storage unit 53 stores therein a plurality of working devices 2 that can be attached to the working machine 1, i.e., identification information for identification of the working devices 2 such as the names, model numbers, product numbers, and/or the like of the working devices 2, work content of each of the working devices 2, the categories thereof, and/or the like, and the work acquisition unit 51e acquires a corresponding working device 2 or work content of the working device 2 stored in the storage unit 53 on the basis of the information inputted into the input device.

The work dimension acquisition unit 51f acquires a widthwise work range w1 of the working device 2 (a widthwise work range w1 of a spreader is particularly referred to as a widthwise spreading work range w3). As illustrated in FIGS. 3B and 3C, the widthwise work range w1 of the working device 2 (hereinafter referred to as a first work dimension) is a width over which the working device 2 does work against the ground such as an agricultural filed (width over which work is done). Furthermore, the first work dimension w1 is, for example, the greatest widthwise dimension of the range where work is done by the working device 2.

As illustrated in FIG. 3C, in the case where the working device 2 is a working device 2 that spreads a material onto the agricultural field such as a fertilizer spreader, the first work dimension w1, i.e., the widthwise spreading work range (hereinafter referred to as a first spreading dimension) w3, is a width over which fertilizer spreading is performed, and the first spreading dimension w3 can be changed by controlling, for example, an opening angle of a shutter for passage of fertilizer by operating the fertilizer spreader. The first spreading dimension w3 varies depending on the particle size of the fertilizer. Specifically, as the particle size of the fertilizer to be spread by the fertilizer spreader increases, the first spreading dimension w3 decreases, whereas, as the particle size of the fertilizer decreases, the first spreading dimension w3 increases.

The work dimension acquisition unit 51f acquires the first work dimension w1 on the basis of information received by the display device 50. Specifically, input screen(s) M5 and/or M6 displayed on the display device 50, i.e., an input device, receives input of the first work dimension w1, and the storage unit 53 stores the first work dimension w1 such that the first work dimension w1 is associated with a corresponding working device 2. The work dimension acquisition unit 51f is capable of acquiring the first work dimension w1 from the storage unit 53 on the basis of the information acquired by the work acquisition unit 51e.

The route preparation unit 51h refers to an agricultural field map MP registered in the storage unit 53, and prepares a travel route (planned travel route) L for automatic travel of the working machine 1 on the agricultural field map MP, as illustrated in FIG. 3A. The planned travel route L includes straight section(s) (straight route(s)) L1 on which the working machine 1 travels straight and turn section(s) (turn route(s)) L2 on which the working machine 1 turns. The straight section(s) L1 is/are mainly prepared in the work area E2, and the turn section(s) L2 is/are mainly prepared in the turn area E1.

The range acquisition unit 51g acquires a front-rear work range w2 of the working device 2 (hereinafter referred to as second work dimension). The range acquisition unit 51g acquires the second work dimension w2 on the basis of information received by the input device. As illustrated in FIGS. 3B and 3C, the second work dimension w2 of the working device 2 is a front-rear dimension over which the working device 2 does work against the ground such as an agricultural field, and is, for example, the largest front-rear dimension from the front edge to the rear edge of the range w2 where work is done by the working device 2. Note that, when the working device 2 is a working device 2 that spreads a material onto the agricultural field such as a spreader, the second work dimension w2 is a rearward spreading distance.

First, the following description discusses a case in which the range acquisition unit 51g acquires the second work dimension w2 of a working device 2 other than a spreader which does fertilizer spreading work. The storage unit 53 stores the second work dimension w2 such that the second work dimension w2 is associated with the working device 2, and the range acquisition unit 51g is capable of acquiring the second work dimension w2 from the storage unit 53 on the basis of information acquired by the work acquisition unit 51e. Thus, when the working device 2 linked to the linkage is not a spreader such as a fertilizer spreader, an agricultural chemical spreader, a water spreader, or the like, the range acquisition unit 51g acquires a pre-set second work dimension w2 from the storage unit 53. Note that, although the second work dimension w2 is pre-stored in the storage unit 53 in the above preferred embodiment, the work dimension w2 may be pre-stored in the storage unit 53 such that the work dimension w2 is associated with its corresponding working device 2 and may be changeable as needed.

Next, the following description discusses an example case in which the range acquisition unit 51g acquires a spreading work range w4 that is a range where spreading work is done by a spreader in a front-rear direction thereof, i.e., a rearward spreading distance w4 (hereinafter referred to as a second spreading dimension). The input screen M6 displayed on the display device 50, i.e., an input device, receives input of the second spreading dimension w4, and the storage unit 53 stores the second spreading dimension w4 such that the second spreading dimension w4 is associated with the spreader. The range acquisition unit 51g is capable of acquiring the second spreading dimension w4 from the storage unit 53 on the basis of the information about the working device 2 acquired by the work acquisition unit 51e. Thus, when the working device 2 linked to the linkage is a spreader, the range acquisition unit 51g acquires, from the storage unit 53, the second spreading dimension w4 which has been inputted into and received by the display device 50 and which is associated with the spreader.

The work setting unit 51i sets work start position(s) STn and work end position(s) ETn for the working device 2. The work setting unit 51i sets the work start position(s) STn and the work end position(s) ETn for the spreader so that the work start position STn and the work end position(s) ETn are at different positions according to the spreading work range w4 acquired by the range acquisition unit 51g. The work setting unit 51i sets the work start position(s) STn and the work end position(s) ETn for the working device 2 on the planned travel route L according to the working device 2 linked to the linkage. The work setting unit 51i sets the work start position(s) STn and the work end position(s) ETn on the basis of, for example, a boundary X1 between the work area E2 and the turn area E1. Furthermore, the work setting unit 51i sets the work start position(s) STn and the work end position(s) ETn on the planned travel route L.

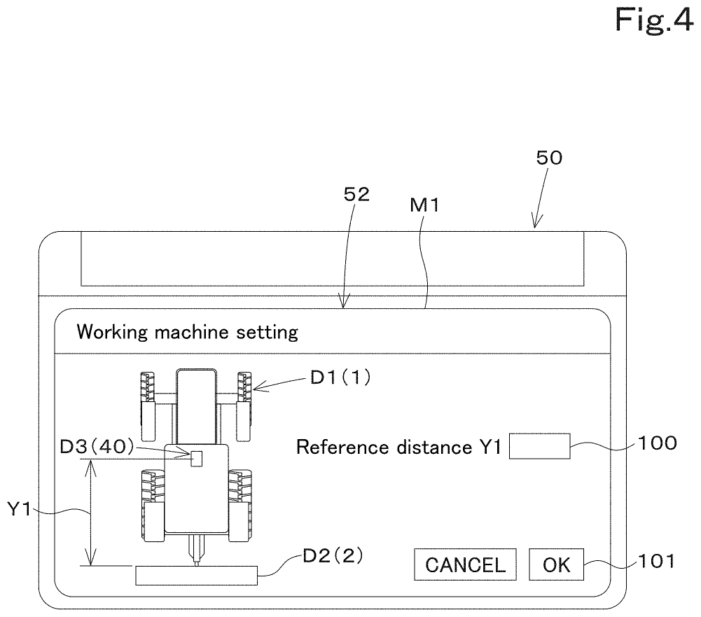

The following description discusses, in detail, a screen displayed on the display unit 52 of the display device 50 and the acquisition of the reference distance Y1 by the information acquisition unit 51a. Upon predetermined operation on the display device 50 by an operator, the display device 50 displays, on the display unit 52, a reference setting screen M1 for input of information (for example, information about dimension(s) including the reference distance Y1) about the working machine 1, as illustrated in FIG. 4. The reference setting screen M1 includes a shape D1 representing the working machine (tractor) 1, a shape D2 representing the working device 2, and a shape D3 representing the positioning device 40. The reference setting screen M1 includes a distance input section 100 for input of the reference distance Y1 and a first input confirmation button 101.

The distance input section 100 is for input of the reference distance Y1. The reference distance Y1 is inputted by operating a predetermined operation item displayed in the reference setting screen M1, an operation switch on the display device 50, and/or the like.

The first input confirmation button 101 is a piece of graphics via which operation to confirm the reference distance Y1 inputted into the distance input section 100 can be performed, i.e., via which operation to confirm the reception of the input of the reference distance Y1 can be performed. Thus, upon input of the reference distance Y1 into the distance input section 100 and operation of the first input confirmation button 101, the storage unit 53 stores the reference distance Y1 inputted into the distance input section 100 such that the reference distance Y1 is associated with the working machine 1. The information acquisition unit 51a acquires the reference distance Y1 from the storage unit 53 on the basis of information acquired by the information acquisition unit 51a.

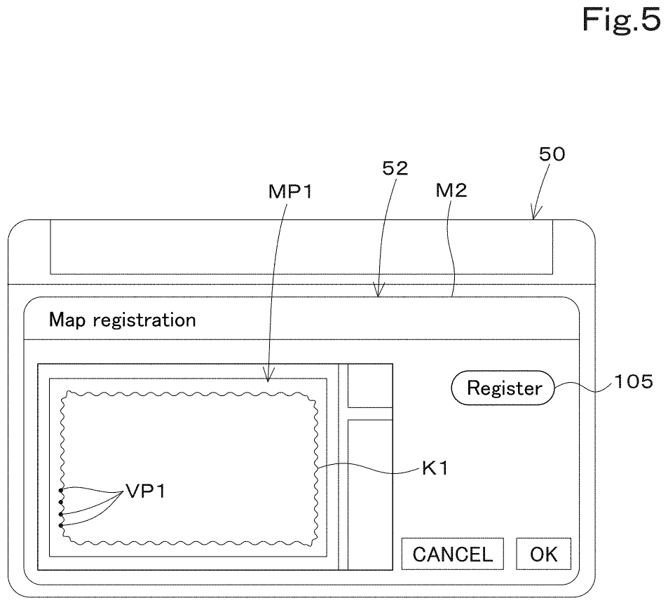

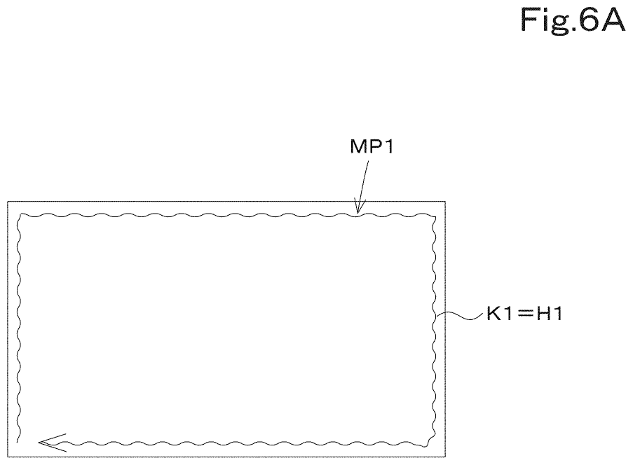

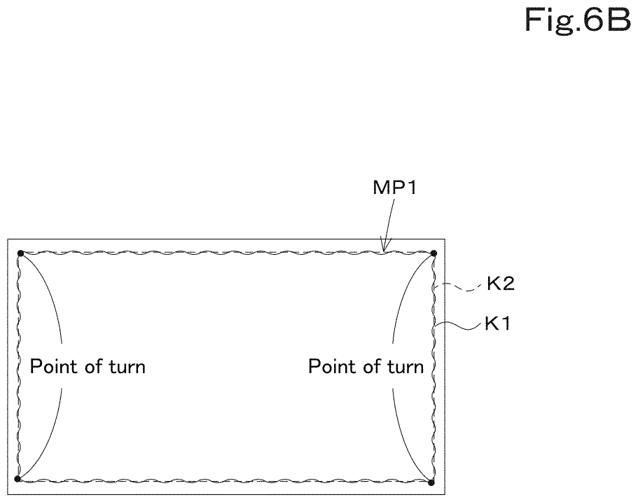

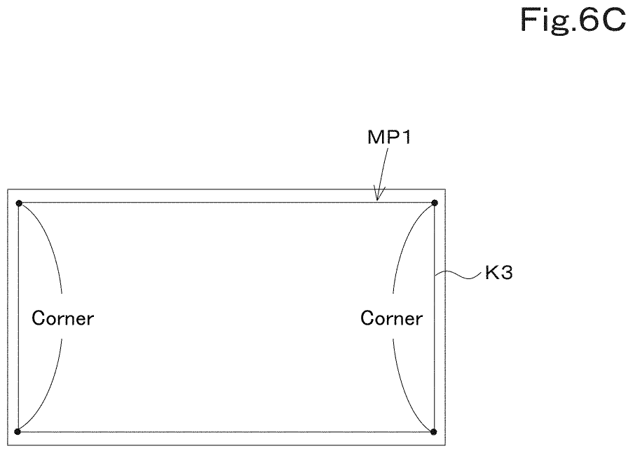

The following description discusses, in detail, a screen displayed on the display unit 52 of the display device 50 and registration of a map by the map registration unit 51b. As illustrated in FIG. 5, upon predetermined operation on the display device 50, the display device 50 displays a map registration screen M2 on the display unit 52. The map registration screen M2 displays a map MP1 including an agricultural field, machine body position(s) VP1 of the working machine 1, and agricultural field identification information such as the name of the agricultural filed, the identifier of the agricultural field, and/or the like. The map MP1 is associated with position information such as latitude and longitude in addition to image data representing the agricultural field. Once the working machine 1 has entered the agricultural field and traveled around the agricultural field, the map registration screen M2 displays the current machine body position(s) VP1 detected by the positioning device 40 when the working machine 1 was traveling around. Once the working machine 1 has traveled around the agricultural field and a register button 105 displayed on the map registration screen M2 has been operated, as illustrated in FIG. 6A, the map registration unit 51b uses, as an outline (outer edge) H1 of the agricultural field, a traveled path K1 obtained from a plurality of machine body positions VP1 obtained when the working machine 1 was traveling around the agricultural field, and registers an agricultural field map MP defined by the outline H1 together with the agricultural field identification information.

Note that the map registration unit 51b may register, as the outline H1 (agricultural field map MP) of the agricultural field, an outline K2 connecting points of turn calculated from the traveled path indicated by the machine body positions VP1 as illustrated in FIG. 6B, and may register, as the outline H1 (agricultural field map MP), an outline K3 connecting corners of an agricultural field designated by a driver or the like using a switch or the like on the working machine 1 when the working machine 1 travels around as illustrated in FIG. 6C. The above-described methods of registering the agricultural field are examples, and do not imply any limitation. The outline of the agricultural field, i.e., the agricultural field map MP, may be data indicated by positions (latitude, longitude), may be data indicated by a coordination system (X axis, Y axis), and may be data indicated in some other manner.

The storage unit 53 stores the agricultural field map MP which indicates the outline (contour) registered by the map registration unit 5 lb. That is, the storage unit 53 stores the agricultural field map MP, i.e., data indicating the outline of the agricultural field (data to represent a certain agricultural field).

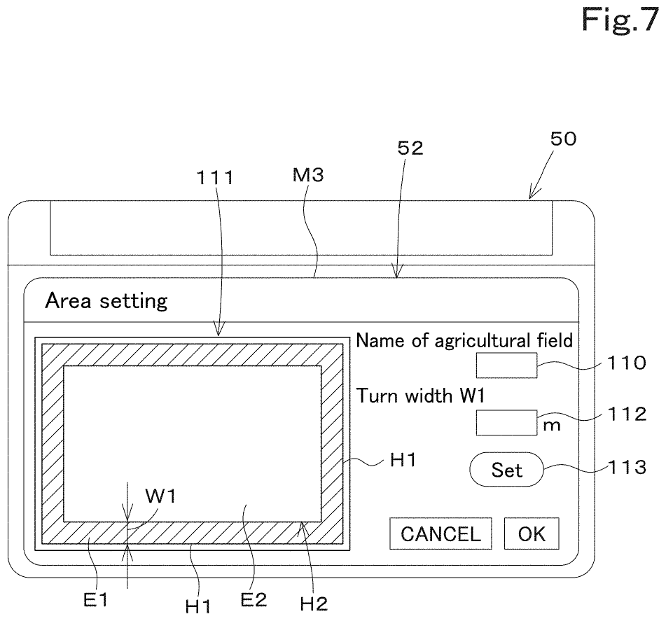

The following description discusses, in detail, a screen displayed on the display unit 52 of the display device 50, the acquisition of the width of the turn area E1 by the turn width acquisition unit 51c, and setting of the work area E2 by the area setting unit 51d. As illustrated in FIG. 7, upon predetermined operation on the display device 50 by an operator (driver), the display device 50 displays an area setting screen M3 on the display unit 52. The area setting screen M3 includes an agricultural field input section 110, an agricultural field display section 111, a turn width input section 112, and a turn setting button 113. The agricultural field input section 110 is for input of agricultural field identification information such as the name of an agricultural field and the identifier of the agricultural field. The agricultural field display section 111 displays an agricultural field map MP representing a predetermined agricultural field corresponding to the agricultural field identification information inputted into the agricultural field input section 110. That is, the control unit 51 sends a request for an agricultural field map MP corresponding to the agricultural field identification information inputted into the agricultural field input section 110 to the storage unit 53, and causes the agricultural field map MP sent from the storage unit 53 to be displayed in the agricultural field display section 111.

The turn width input section 112 is for input of the turn width W1 of a predetermined agricultural field corresponding to the agricultural field identification information inputted into the agricultural field input section 110. The turn setting button 113 is a piece of graphics via which operation to confirm the turn width W1 inputted into the turn width input section 112, i.e., confirm the reception of input of the turn width W1, can be performed. Thus, upon input of the turn width W1 into the turn width input section 112 and operation of the turn setting button 113, the turn width acquisition unit 51c acquires the turn width W1 inputted into the turn width input section 112.

Furthermore, once the turn setting button 113 has been selected and the turn width acquisition unit 51c has acquired the turn width W1 inputted into the turn width input section 112, the area setting unit 51d causes the work area E2 excluding the turn area E1 to be displayed on the agricultural field map MP displayed in the agricultural field display section 111. For example, the area setting unit 51d sets, as the work area E2, an area defined by an outline H2 that is offset inward from the outline H1 of the agricultural field map MP by the turn width W1 on the basis of the turn width W1 acquired by the turn width acquisition unit 51c. Note that the work area E2 may be set on the agricultural field map MP by designating the position of the outline of the work area E2 using a pointer or the like on the agricultural field map MP displayed in the agricultural field display section 111 of the area setting screen M3.

The storage unit 53 stores data of the agricultural field map MP on which the work area E2 is set, i.e., data indicating the position of the work area E2 on the agricultural field map MP.

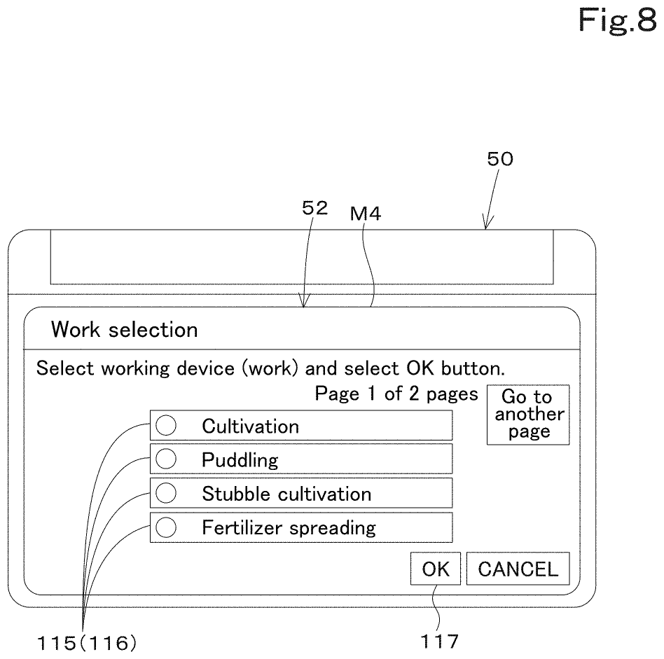

The following description discusses, in detail, a screen displayed on the display unit 52 of the display device 50 and the acquisition of the working device 2 or the work category or the like of the working device 2 by the work acquisition unit 51e. As illustrated in FIG. 8, upon predetermined operation on the display device 50 by an operator (driver), the display device 50 displays a work selection screen M4 on the display unit 52. The work selection screen M4 includes a selection section 115. The selection section 115 enables operation of selection among a plurality of working devices 2 that can be attached to the working machine 1, i.e., operation to input identification information for identification of a working device 2 such as the name, model number, product number, and/or the like of the working device 2, work content of the working device 2 or the category thereof, and/or the like.

As illustrated in FIG. 8, the selection section 115 includes, for example, a plurality of selection members 116, and the plurality of selection members 116 are pieces of graphics associated with pieces of identification information for identification of working devices 2 such as the names, model numbers, or product numbers of the working devices 2 and/or the content of work done by the working devices 2 or categories thereof. In the present preferred embodiment, as illustrated in FIG. 8, the selection members 116 are associated with the work categories of the working devices 2, and the work categories associated with the plurality of selection members 116 at least include “fertilizer spreading”, and, for example, the plurality of selection members 116 are associated with “cultivation”, “puddling”, “stubble cultivation”, and “fertilizer spreading”, respectively. Thus, once operation to select any of the plurality of selection members 116 has been performed, the work category of a working device 2 is selected. Note that the work categories associated with the plurality of selection members 116 may include, for example, “agricultural chemical spreading”, “watering”, “seeding”, “reaping”, and/or the like, and the categories are not limited to those described above.

Furthermore, as illustrated in FIG. 8, the work selection screen M4 includes a selection confirmation button 117. The selection confirmation button 117 is a piece of graphics which is operable. By selecting a work category of a working device 2 by operating one of the selection members 116 and operating the selection confirmation button 117, the selection of the work category of the working device 2 by operation of the selection member 116 is confirmed. Thus, once the selection confirmation button 117 has been operated, the work acquisition unit 51e acquires, from the storage unit 53, the work category associated with the selection member 116 which has been selected.

Note that, although the selection members 116 are associated with work categories and the work acquisition unit 51e acquires a work category from the storage unit 53 in the present preferred embodiment, the selection members 116 need only be associated with at least one of the identification information for identification of the working devices 2 such as the names, model numbers, or product numbers of the working devices 2, work content of the work devices 2, and the like, and the work acquisition unit 51e need only be capable of acquiring information which makes it possible to identify the working devices 2. The work acquisition unit 51e may acquire names or product numbers instead of the work categories.

The following description discusses, in detail, a screen displayed on the display unit 52 of the display device 50, the acquisition of the first work dimension w1 by the work dimension acquisition unit 51f, the acquisition of the second work dimension w2 of the working device 2 by the range acquisition unit 51g, the preparation of the planned travel route L by the route preparation unit 51h, and setting of work start and work end for the working device 2 by the work setting unit 51i.

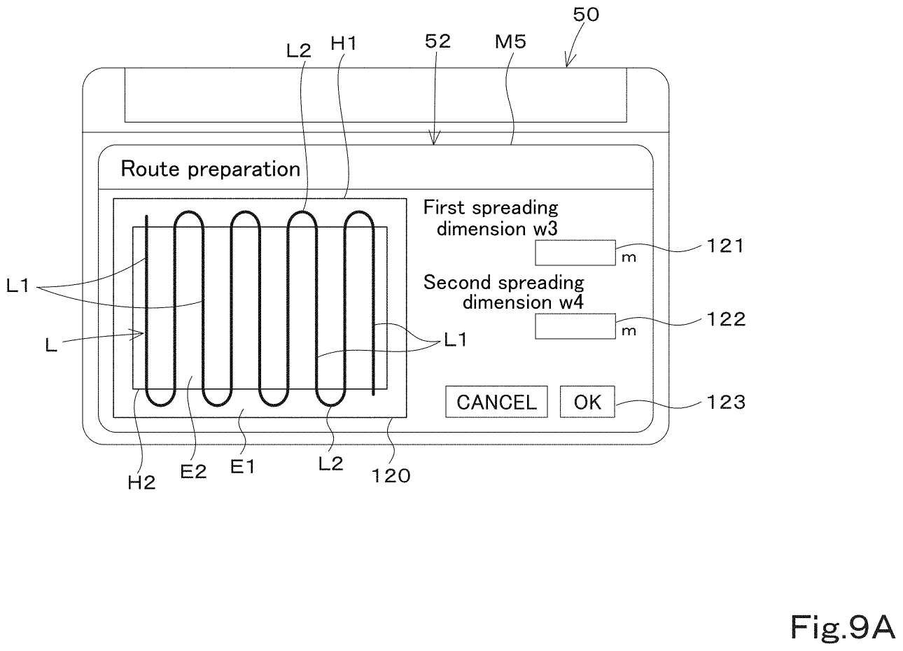

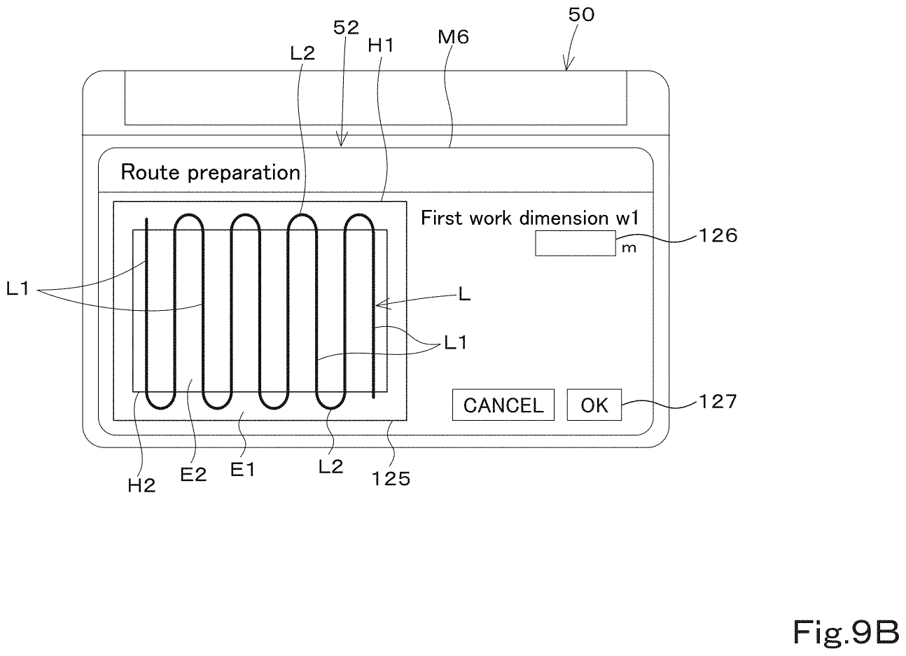

In the case where the operator (driver) has performed operation to select a working device 2 on the work selection screen M4 and the working device 2 acquired by the work acquisition unit 51e is a spreader that does fertilizer spreading work, agricultural chemical spreading work, water spreading work, or the like, the display device 50 displays a first settings screen M5 on the display unit 52 of the display device 50 as illustrated in FIG. 9A. The first settings screen M5 is an input screen for input of at least the second spreading dimension w4, and, on the basis of the inputted second spreading dimension w4, the work start position(s) STn and the work end position(s) ETn can be set at different positions. Furthermore, in the first settings screen M5, the first spreading dimension w3 can be inputted, and the planned travel route L can be set in the work area E2 on the basis of the inputted first spreading dimension w3. The first settings screen M5 includes a route display section 120 in which a planned travel route L is displayed, a first dimension input section 121, a second dimension input section 122, and a second input confirmation button 123.

The first dimension input section 121 is for input of the first spreading dimension w3 corresponding to the spreader which has been selected on the work selection screen M4. The second dimension input section 122 is for input of the second spreading dimension w4 corresponding to the spreader which has been selected on the work selection screen M4. The first spreading dimension w3 and the second spreading dimension w4 are each inputted by operating a predetermined operation item displayed on the first settings screen M5, an operation switch on the display device 50, and/or the like.

The second input confirmation button 123 is a piece of graphics via which operation to confirm the first spreading dimension w3 inputted into the first dimension input section 121 and the second spreading dimension w4 inputted into the second dimension input section 122, that is, confirm the reception of input of the first spreading dimension w3 and the second spreading dimension w4, can be performed. Thus, once the first spreading dimension w3 has been inputted into the first dimension input section 121, the second spreading dimension w4 has been inputted into the second dimension input section 122, and the second input confirmation button 123 has been selected, the storage unit 53 stores the first spreading dimension w3 and the second spreading dimension w4 such that the first spreading dimension w3 and the second spreading dimension w4 are associated with the spreader. The work dimension acquisition unit 51f acquires the first spreading dimension w3 from the storage unit 53 on the basis of information acquired by the work acquisition unit 51e. Furthermore, the range acquisition unit 51g acquires the second spreading dimension w4 from the storage unit 53 on the basis of information acquired by the work acquisition unit 51e.

In the case where the operator (driver) has performed operation to select a working device 2 on the work selection screen M4 and the working device 2 acquired by the work acquisition unit 51e is a working device 2 other than spreaders such as a fertilizer spreader, an agricultural chemical spreader, and a water spreader, as illustrated in FIG. 9B, the display device 50 displays a second settings screen M6 on the display unit 52. The second settings screen M6 is a screen which is for input of the first work dimension w1 and in which a planned travel route L can be set in the work area E2 on the basis of the inputted first work dimension w1. The second settings screen M6 includes a route display section 125 in which the planned travel route L is displayed, a third dimension input section 126, and a third input confirmation button 127.

The third dimension input section 126 is for input of the first work dimension w1 corresponding to the working device 2 which has been selected on the work selection screen M4. The first work dimension w1 is inputted by operating a predetermined operation item displayed on the second settings screen M6, an operation switch on the display device 50, and/or the like.

The third input confirmation button 127 is a piece of graphics via which operation to confirm the first work dimension w1 inputted into the third dimension input section 126, i.e., confirm the reception of input of the first work dimension w1, can be performed. Thus, upon input of the first work dimension w1 into the third dimension input section 126 and selection of the third input confirmation button 127, the storage unit 53 stores the first work dimension w1 such that the first work dimension w1 is associated with the working device 2. The work dimension acquisition unit 51f acquires the first work dimension w1 from the storage unit 53 on the basis of information acquired by the work acquisition unit 51e. Furthermore, the range acquisition unit 51g acquires a pre-set second work dimension w2 from the storage unit 53 on the basis of information acquired by the work acquisition unit 51e.

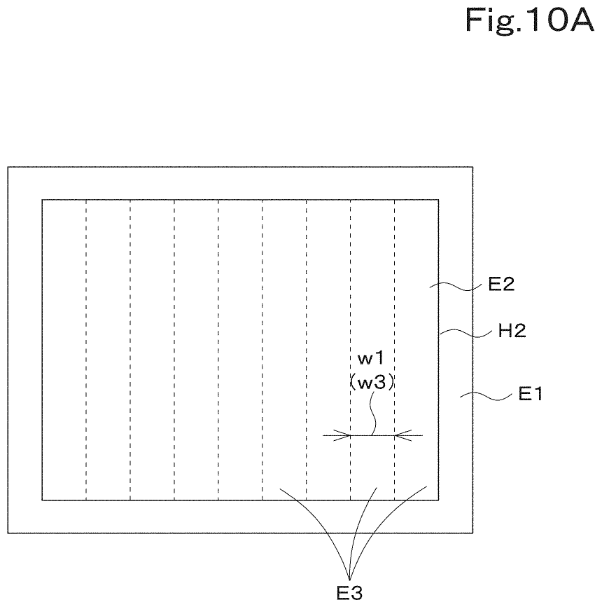

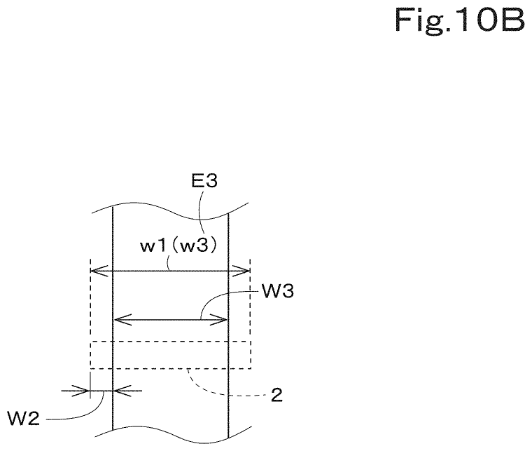

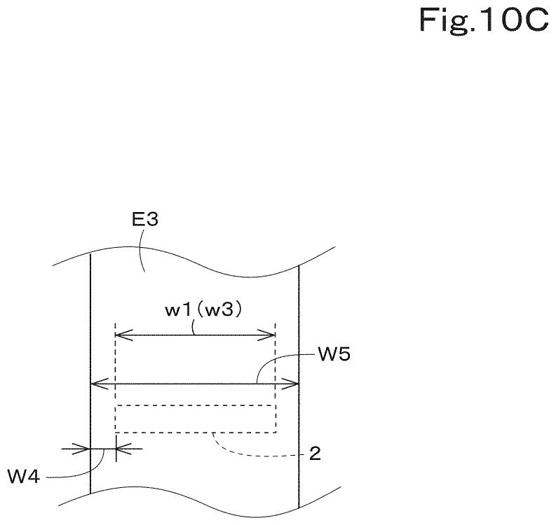

Once the work dimension acquisition unit 51f has acquired the first work dimension w1 (the first spreading dimension w3 when the working device 2 is a spreader), the route preparation unit 51h divides the work area E2 into vertically or horizontally arranged areas each having the first work dimension w1 to prepare, in the work area E2, a plurality of unit work segments E3 in each of which work is to be done by the working device 2, as illustrated in FIG. 10A. That is, the route preparation unit 51h prepares a plurality of unit work segments E3 each of which has a width equal to the first work dimension w1 in the work area E2. Note that, as illustrated in FIG. 10B, the route preparation unit 51h may prepare, in the work area E2, a plurality of unit work segments E3 each having a width W3 obtained by excluding overlapping width(s) W2 from the first work dimension w1. The overlapping width W2 can be inputted on a predetermined screen displayed on the display unit 52. That is, the route preparation unit 51h sets, as each unit work segment E3, the smallest unit area in which work is done against the agricultural field by the working device 2 when the machine body 3 with the working device 2 linked thereto is caused to travel. Furthermore, as illustrated in FIG. 10C, the route preparation unit 51h may prepare, in the work area E2, a plurality of unit work segments E3 each having a width W5 obtained by adding underlapping width(s) W4 to the first work dimension w1. The underlapping width W4 can be inputted on a predetermined screen displayed on the display unit 52.

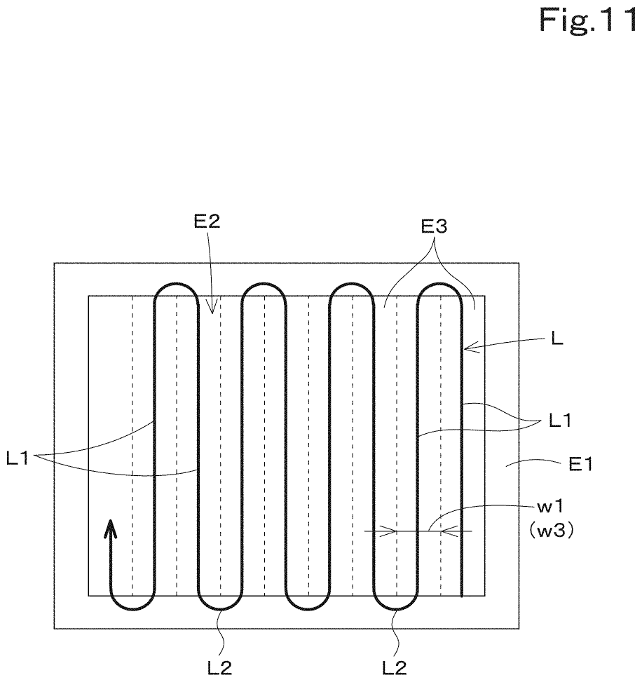

As illustrated in FIG. 11, the route preparation unit 51h prepares straight sections L1 on which the machine body 3 travels straight for the respective unit work segments E3 of the agricultural field map MP. That is, for example, the route preparation unit 51h prepares, in the widthwise middle portion of each unit work segment E3, a straight section L1 in the form of a continuous straight line which connects opposite ends of the unit work segment E3 in the lengthwise direction and which extends into, over, or across the turn area E1, the work area E2, and the boundary X1. Furthermore, the route preparation unit 51h prepares turn section(s) L2 connecting end portions of adjacent straight sections L1. That is, the route preparation unit 51h prepares the turn section(s) L2 at least in the turn area E1.

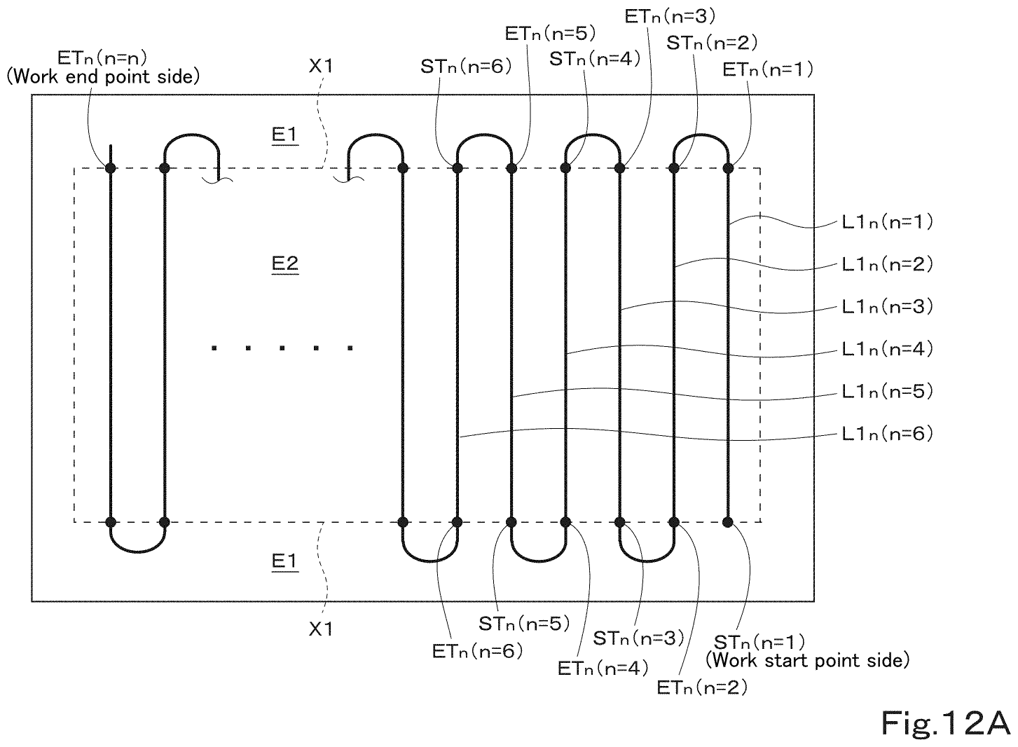

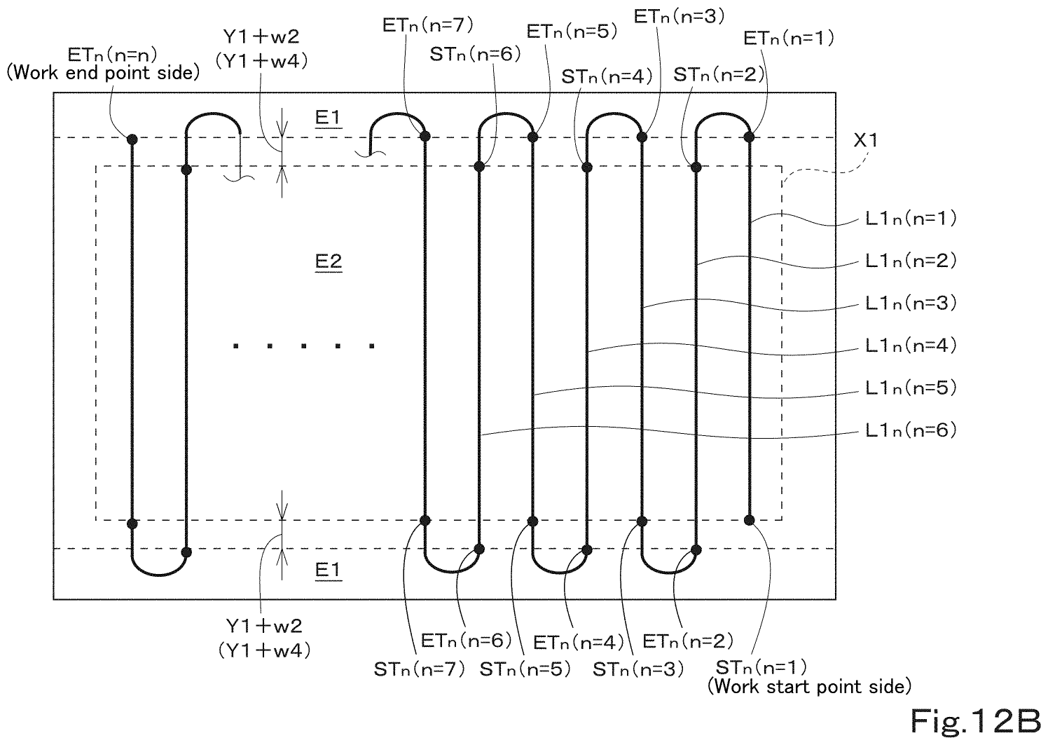

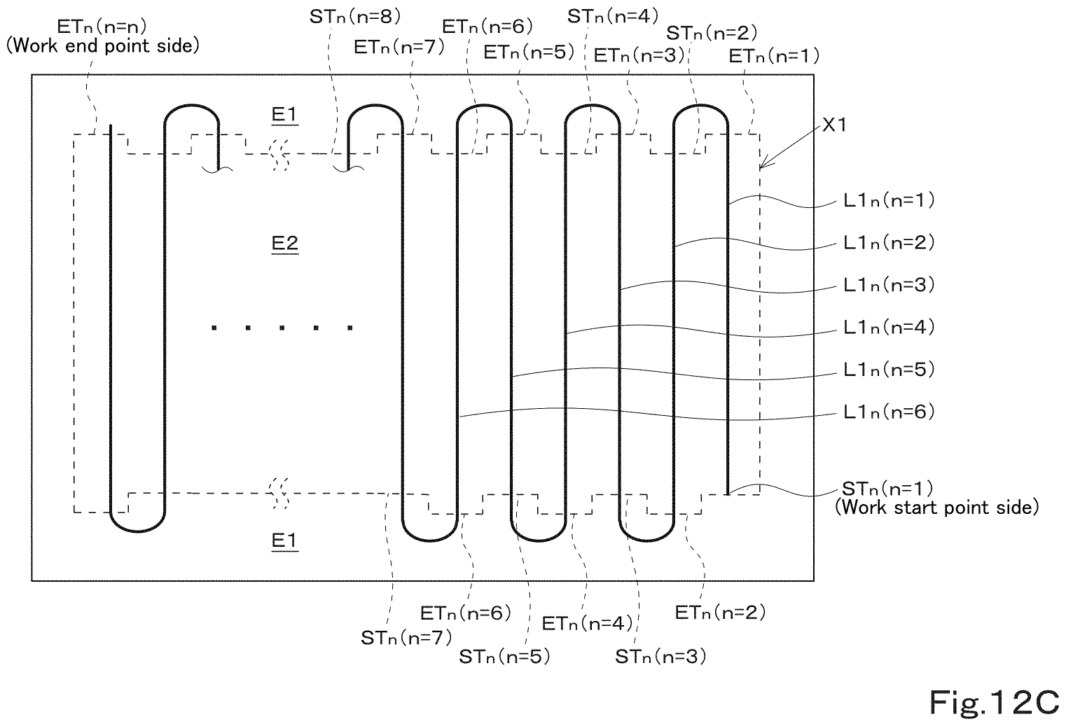

Furthermore, once the range acquisition unit 51g has acquired the second work dimension w2 (the second spreading dimension w4 when the working device 2 is a spreader), the work setting unit 51i sets work start and work end for the working device 2. As illustrated in FIG. 12B, the work setting unit 51i sets work start position(s) STn and work end position(s) ETn on the basis of the boundary X1 between the work area E2 and the turn area E1 and the second spreading dimension w4. The work setting unit 51i sets the work start position(s) STn and the work end position(s) ETn on the planned travel route L.

Specifically, when the working device 2 is a spreader, the work setting unit 51i sets a work start position STn and a work end position ETn which are adjacent to each other so that the work start position STn and the work end position ETn are at different positions in the front-rear direction of the machine body 3 (working device 2) according to at least the second spreading dimension w4. In the present preferred embodiment, the work setting unit 51i sets the work start position STn and the work end position ETn so that the work start position STn and the work end position ETn are at different positions on the basis of the reference distance Y1 acquired by the information acquisition unit 51a and the second work dimension w2 (second spreading dimension w4) acquired by the range acquisition unit 51g.

Specifically, as illustrated in FIG. 12A, on the planned travel route L, assuming that each straight section L1 is referred to as a straight section L1n (n=1, 2, . . . and n, where 1 means a work start point side and n means a work end point side), the work setting unit 51i sets one of opposite ends of each straight section L1n where n is an even number (n=2, 4, 6 . . . and so on) (i.e., the end on the same side as the work end point) as a work start position STn (n=2, 4, 6 . . . and so on). Furthermore, the work setting unit 51i sets one of opposite ends of each straight section L1n where n is an odd number (n=1, 3, 5 . . . and so on) (the end that is on the same side as the work start point) as a work start position STn (n=1, 3, 5 . . . and so on).

As illustrated in FIG. 12A, the work setting unit 51i sets the other of the opposite ends of each straight section L1n where n is an odd number (n=1, 3, 5 . . . and so on) (the end that is on the same side as the work end point) as a work end position ETn (n=1, 3, 5 . . . and so on). Furthermore, the work setting unit 51i sets the other of the opposite ends of each straight section L1n where n is an even number (n=2, 4, 6 . . . and so on) (the end that is on the same side as the work start point) as a work end position ETn (n=2, 4, 6 . . . and so on).

As illustrated in FIG. 12B, the work setting unit 51i shifts the work end positions ETn (n=2, 4, 6 . . . and so on) that are on the same side as the work start point in FIG. 12A into the turn area E1 by at least the sum of the reference distance Y1 and the second work dimension w2 (Y1+w2). The route preparation unit 51h extends the straight section L1n (n=2, 4, 6 . . . and so on) that corresponds to each shifted work end position ETn (n=2, 4, 6 . . . and so on) to the shifted work end position ETn (n=2, 4, 6 . . . and so on).

Furthermore, as illustrated in FIG. 12B, the work setting unit 51i shifts the work end positions ETn (n=1, 3, 5 . . . and so on) that are on the same side as the work end point in FIG. 12A into the turn area E1 by at least the sum of the reference distance Y1 and the second work dimension w2 (Y1+w2). The route preparation unit 51h extends the straight section L1n (n=1, 3, 5 . . . and so on) that corresponds to each shifted work end position ETn (n=1, 3, 5 . . . and so on) to the shifted work end position ETn (n=1, 3, 5 . . . and so on).

Note that, although the work setting unit 51i in the present preferred embodiment sets the work start position(s) STn and the work end position(s) ETn so that the work start position(s) STn and the work end position(s) ETn are at different positions on the basis of the reference distance Y1 acquired by the information acquisition unit 51a and the second work dimension w2 acquired by the range acquisition unit 51g, the work setting unit 51i need only set the work start position(s) STn and the work end position(s) ETn so that the work start position(s) STn and the work end position(s) ETn are at different positions based at least on the second spreading dimension w4 acquired by the range acquisition unit 51g, and a method thereof is not limited to that described above.

Furthermore, although the work start positions STn and the work end positions ETn are set on the planned travel route L (straight sections L1n) with the turn area E1 and the work area E2 kept unchanged, the work setting unit 51i may shift ends of the unit work segments E3 of the work area E2 into the turn area E1 by at least the second work dimension w2 and set the work start positions STn and the work end positions ETn on the boundary X1 between the work area E2 and the turn area E1 (see FIG. 12C).

The following description discusses automatic travel in detail. As illustrated in FIG. 1, the working machine 1 includes a control device 60. The control device 60 is a device to control the traveling system of the working machine 1, control the working system of the working machine 1, and/or the like. The control device 60 has connected thereto an operation changeover switch 65. The operation changeover switch 65 is a switch capable of being switched between ON and OFF. When the operation changeover switch 65 is in the ON state, the control device 60 can be set to an automatic travel mode, and when the operation changeover switch 65 is in the OFF state, the control device 60 can be set to a manual operation mode.

The control device 60 includes an automatic travel control unit 63. The automatic travel control unit 63 includes electric/electronic circuit(s) provided in the control device 60, program(s) stored in a CPU and/or the like in the control device 60, and/or the like.

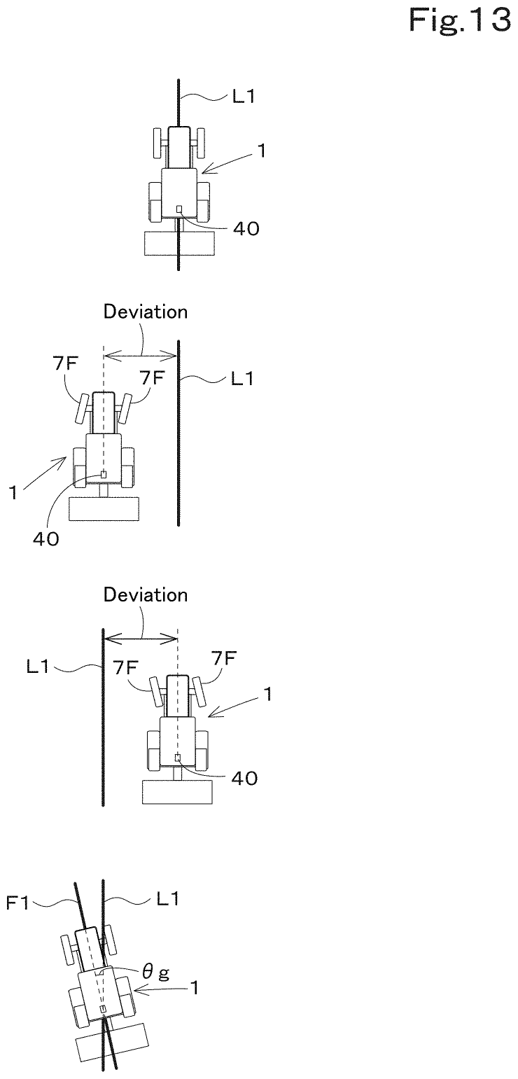

The automatic travel control unit 63 controls automatic travel of the machine body 3. The automatic travel control unit 63 starts the automatic travel when the working machine 1 is in an automatic travel mode. As illustrated in FIG. 13, when the working machine 1 is performing automatic travel, if the deviation between the machine body position VP1 and the planned travel route L is less than a threshold, the automatic travel control unit 63 maintains the angle of rotation of the steering shaft (rotation shaft) 31. If the deviation between the machine body position VP1 and the planned travel route L is equal to or greater than the threshold and the working machine 1 is positioned leftward of the planned travel route L, the automatic travel control unit 63 causes the steering shaft 31 to rotate so that the working machine 1 is steered right. If the deviation between the machine body position VP1 and the planned travel route L is equal to or greater than the threshold and the working machine 1 is positioned rightward of the planned travel route L, the automatic travel control unit 63 causes the steering shaft 31 to rotate so that the working machine 1 is steered left.

Note that, although the angle of steering by the steering unit 29 is changed on the basis of the deviation between the machine body position VP1 and the planned travel route L in the above-described preferred embodiment, the automatic travel control unit 63 may, in the case where the direction of the planned travel route L and the travel direction F1 of the working machine 1 (machine body 3) (machine body heading direction) differ from each other, i.e., in the case where an angle of the machine body heading direction F1 to the planned travel route L is equal to or greater than a threshold, set the angle of steering so that the angle is zero (the machine body heading direction F1 matches the direction of the planned travel route L). The automatic travel control unit 63 may set the final angle of steering for the automatic travel on the basis of an angle of steering determined based on the deviation (deviation in position) and an angle of steering determined based on the direction (deviation in direction) F1. Settings of the angle of steering in automatic travel in the above-described preferred embodiments are examples, and do not imply any limitation.

Note that, in the case where the planned travel route L is associated with vehicle speed, the automatic travel control unit 63 automatically changes the speed stage of the transmission 5, the speed of rotation of the prime mover 4, and/or the like so that the current speed of the working machine 1 matches the vehicle speed that corresponds to the planned travel route L.

The control device 60 controls the working device 2 according to the work start position(s) STn and the work end position(s) ETn set by the work setting unit 51i. Specifically, the automatic travel control unit 63 of the control device 60 controls the working device 2 on the basis of the work start position(s) STn and the work end position(s) ETn set by the work setting unit 51i, the position(s) of the machine body 3 measured by the positioning device 40, and the reference distance Y1. For example, the automatic travel control unit 63 starts driving the working device 2 by outputting a start signal to a driving device (drive motor) of the working device 2, and stops the driving by outputting a stop signal.

The automatic travel control unit 63 starts driving the working device 2 (causes the working device 2 to start doing work) when, under the conditions in which the working machine 1 is traveling while performing automatic travel at least along a turn section L2, the working device 2 has passed through a work start position STn.

On the contrary, the automatic travel control unit 63 stops driving the working device 2 (causes the working device 2 to stop doing the work) when, under the conditions in which the working machine 1 is traveling while performing automatic travel at least along the turn section L2, the working device 2 has passed through a work end position ETn.

Note that the control device 60 need only cause the working device 2 to start doing work when the working device 2 linked to the linkage has passed through a work start position STn and causes the working device 2 to stop doing the work when the working device 2 has passed through a work end position ETn, and a method of such control is not limited to that described above.

In the above-described preferred embodiments, the control device 60 (automatic travel control unit 63) starts the driving by outputting a start signal to a drive motor and stops the driving by outputting a stop signal. However, the control device 60 need only be capable of controlling starting and stopping of the driving of the working device 2, and may control the starting and stopping of the driving of the driving device by, for example, controlling a PTO clutch 155 (which is capable of switching between a connected state in which power from the PTO shaft is transmitted to the working device 2 and a disconnected state in which the power is not transmitted to the working device 2) to switch the connected state to the disconnected state. Any method of controlling the starting and stopping of the driving of the working device 2 may be used.

A working machine 1 as has been described includes a machine body 3, a linkage capable of linking a working device 2 including a spreader to the machine body 3, an automatic travel controller 63 to cause the machine body 3 to perform automatic travel according to a planned travel route L, a range acquirer 51g to acquire a spreading work range w4 that is a range where spreading work is done by the spreader in a front-rear direction thereof, and a work setter 51i to set a work start position STn and a work end position ETn for the spreader so that the work start position STn and the work end position ETn are at different positions according to the spreading work range w4 acquired by the range acquirer 51g. The configuration makes it possible to change the position at which work is started and the position at which the work is ended according to the spreading work range w4 that is a range where spreading work is done by the spreader in the front-rear direction. This makes it possible to do work at intended positions even in cases of a fertilizer spreader, an agricultural chemical spreader, a water spreader, or the like which differ relatively greatly in front-rear work range w2 compared to other working devices 2, and possible to prevent or reduce unevenness of fertilizer spreading and reduce unplowed land.

The working machine 1 further includes an input to receive input of the spreading work range w4 such that the spreading work range w4 is associated with the spreader, wherein the range acquirer 51g is configured or programmed to acquire the spreading work range w4 received by the input. With the configuration, by inputting the spreading work range w4 into the input, it is possible to adjust the spreading work range w4 as desired. This makes it possible to improve the usefulness of the working machine 1.

The working machine 1 further includes a storage 53 to store the spreading work range w4 received by the input, wherein the input includes a display device 50 to display an input screen M5 to receive input of the spreading work range w4, and the storage 53 stores the spreading work range w4 inputted into and received by the input screen M5 and the spreader corresponding to the spreading work range w4 such that the spreading work range w4 and the spreader are associated with each other. With the configuration, the storage 53 stores the spreading work range w4 and the spreader such that the spreading work range w4 and the spreader are associated with each other, and therefore the working machine 1 is capable of reading out the spreading work range w4 corresponding to the spreader. This eliminates the need for inputting the spreading work range w4 by operating the input every time work is to be done.

The working machine 1 further includes a storage 53 to store the spreading work range w4 received by the input, wherein the storage 53 stores another type of the working device 2 other than the spreader and a pre-set work range w2 such that the other type of the working device 2 and the pre-set work range w2 are associated with each other, the range acquirer 51g is configured or programmed to acquire, if the working device 2 linked to the linkage is the spreader, the spreading work range w4 inputted into and received by the input and associated with the spreader from the storage 53, and acquire, if the working device 2 linked to the linkage is the other type of the working device 2 other than the spreader, the work range w2 from the storage 53, and the work setter 51i is configured or programmed to set the work start position STn and the work end position ETn for the working device 2 linked to the linkage so that the work start position STn and the work end position ETn are at different positions according to the spreading work range w4 or the work range w2 acquired by the range acquirer 51g. With the configuration, the work setter 51i is capable of, if the working device 2 is not a spreader, setting the work start position STn and the work end position ETn according to a predetermined work range w2. Thus, if the working device 2 is other than working devices 2 such as a fertilizer spreader, an agricultural chemical spreader and a water spreader which greatly vary in spreading work range w4 (work range w2) depending on the type of work or the type of working machine 1, the work start position STn and the work end position ETn are set according to the pre-set work range w2. As such, if the working device 2 is not a spreader such as a fertilizer spreader, an agricultural chemical spreader, or a water spreader, the input does not need to be operated, making it possible to improve efficiency and improve usability of the working machine 1.

The working machine 1 further includes a controller 60 to control the working device 2 linked to the linkage according to the work start position STn and the work end position ETn set by the work setter 51i, wherein the controller 60 causes the working device 2 linked to the linkage to start doing work when the working device 2 has passed through the work start position STn and causes the working device 2 to stop doing the work when the working device 2 has passed through the work end position ETn. With the configuration, the working device 2 starts doing work at the work start position STn set by the work setter 51i, and the working device 2 ends the work at the work end position ETn set by the work setter 51i, making it possible for the working machine 1 to do work at intended places.

The working machine 1 further includes a route generator 51h to prepare the planned travel route L, wherein the work setter 51i sets, according to the working device 2 linked to the linkage, the work start position STn and the work end position ETn for the working device 2 on the planned travel route L. With this, since the work start position STn and the work end position ETn are set on the planned travel route L and therefore work is started and ended based on the position of the working machine 1, it is easy to cause the working machine 1 to travel and the working device 2 to do work in a linked manner, making it possible for the working machine 1 to do work more efficiently.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working machine comprising:
a machine body;
a linkage capable of linking a working device including a spreader to the machine body;
an automatic travel controller to cause the machine body to perform automatic travel according to a planned travel route;
a range acquirer to acquire a spreading work range that is a range where spreading work is done by the spreader in a front-rear direction thereof; and
a work setter to set a work start position and a work end position for the spreader so that the work start position and the work end position are at different positions according to the spreading work range acquired by the range acquirer.

2. The working machine according to claim 1, further comprising an input to receive input of the spreading work range such that the spreading work range is associated with the spreader, wherein
the range acquirer is configured or programmed to acquire the spreading work range received by the input.

3. The working machine according to claim 2, further comprising a storage to store the spreading work range received by the input; wherein
the input includes a display device to display an input screen to receive input of the spreading work range; and
the storage is configured or programmed to store the spreading work range inputted into and received by the input screen and the spreader corresponding to the spreading work range such that the spreading work range and the spreader are associated with each other.

4. The working machine according to claim 2, further comprising a storage to store the spreading work range received by the input; wherein
the storage stores another type of the working device other than the spreader and a pre-set work range such that the other type of the working device and the pre-set work range are associated with each other;
the range acquirer is configured or programmed to:
acquire, if the working device linked to the linkage is the spreader, the spreading work range inputted into and received by the input and associated with the spreader from the storage; and
acquire, if the working device linked to the linkage is the other type of the working device other than the spreader, the work range from the storage; and
the work setter is configured or programmed to set the work start position and the work end position for the working device linked to the linkage so that the work start position and the work end position are at different positions according to the spreading work range or the work range acquired by the range acquirer.

5. The working machine according to claim 4, further comprising a controller to control the working device linked to the linkage according to the work start position and the work end position set by the work setter; wherein
the controller causes the working device linked to the linkage to start doing work when the working device has passed through the work start position and causes the working device to stop doing the work when the working device has passed through the work end position.

6. The working machine according to claim 1, further comprising a route generator to prepare the planned travel route; wherein
the work setter is configured or programmed to set, according to the working device linked to the linkage, the work start position and the work end position for the working device on the planned travel route.
